(19) United States
(12) Patent Application Publication
(10) Pub. No.: US 2026/0288350 A1
(43) Pub. Date: Sep. 24, 2026

(54) STORAGE SYSTEM, MANAGEMENT SERVER, AND ACCESS CONTROL METHOD FOR STORAGE SYSTEM

(71) Applicant: Hitachi Vantara, Ltd., Kanagawa-ken (JP)

(72) Inventors: Mutsumi HOSOYA, Tokyo (JP); Koji HOSOGI, Tokyo (JP)

(73) Assignee: Hitachi Vantara, Ltd., Kanagawa-ken (JP)

(21) Appl. No.: 19/324,246

(22) Filed: Sep. 10, 2025

(30) Foreign Application Priority Data
Mar. 18, 2025 (JP) 2025-044073

(51) Int. Cl. G06F 3/06

(52) U.S. Cl. CPC G06F 3/0622; G06F 3/0659; G06F 3/0673

(57) ABSTRACT

When an instruction to operate a memory device is received from a host computer, a storage system specifies a memory device that has a duplication relationship with an operation target among the memory devices. The storage system determines the attribute of the operation target based on the attribute of the specified memory device. The storage system specifies a domain to which the host computer as an operation source belongs and the domain to which the operation target among the memory devices belongs. The storage system determines, based on the attribute of the operation target and the domains to which the host computer and the operation target belong, authority to operate the operation target among the memory devices from the host computer as an operation source, and when a determination is made that authority is granted, operates the operation target among the memory devices.

### BACKGROUND OF THE INVENTION

The present invention relates to a storage system, a management server, and an access control method for storage system.

With the spread of utilization of hybrid clouds, there are concerns of deterioration in the level of data governance due to data diffusion to clouds. In particular, in recent years, higher level of security and more strict compliance are required with growing awareness for personal information protection. In this regard, a data management solution for managing history information of data such as generation, alteration, and reference and performing data governance stipulated in the Act on the Protection of Personal Information and the like has been provided (for example, see JP 2024-085152 A).

### SUMMARY OF THE INVENTION

Disclosed in JP 2024-085152 A is that, when data is to be transferred to another area, whether data transfer is accepted is determined with reference to the information on accept/reject of data transfer, but there is no disclosure of a specific method of generating the information on accept/reject of data transfer and the process of determination. In particular, when there is dependency relationship between many pieces of data across different sites such as in a hybrid cloud and a multi-cloud, the management cost for generating and maintaining the information on accept/reject of data transfer rises, but there is no disclosure of measures to be taken for such a rise of cost.

In addition, the technology disclosed in JP 2024-085152 A requires determination of accept/reject of data transfer for each transfer instruction, which results in the increase in overhead and management cost.

The present invention has been made in view of the above points, and an object of the present invention is to achieve a high level of data governance for a storage system at low cost and low overhead.

To achieve the above object, one aspect of the present invention is a storage system including a host computer, and a storage device including a memory device from which the host computer reads data and to which the host computer writes data, wherein the host computer and the storage device are provided for each domain, the storage system manages device information including information indicating a correspondence between the host computer and the memory device from which the host computer reads data and to which the host computer writes data, information from which the domain which the host computer and the memory device belong to is specified, and information indicating a duplication relationship between the memory devices, and a processor of the storage system specifies based on the device information, when an instruction to operate the memory device is received from the host computer, one among the memory devices having the duplication relationship with an operation target among the memory devices, determines, according to an attribute of the one among the memory devices that has been specified, an attribute of the operation target among the memory devices, specifies, based on the device information, the domain to which the host computer as an operation source and the operation target among the memory devices belong, determines, based on the attribute of the operation target among the memory devices and the domain to which the host computer as an operation source and the operation target among the memory devices belong, authority to operate the operation target among the memory devices from the host computer as an operation source, and operates the operation target among the memory devices when it is determined that the authority is granted.

According to the present invention, a high level of data governance for a storage system can be achieved at low cost and low overhead.

### BRIEF DESCRIPTION OF THE DRAWINGS

FIG. 1 is a diagram illustrating an example of a configuration of a storage system according to an embodiment;

FIG. 2 is a diagram illustrating an example of device configuration information and device relationship information according to the embodiment;

FIG. 3 is a diagram illustrating an example of a device operation authority determination matrix according to the embodiment;

FIG. 4 is a flowchart illustrating device operation authority determination processing according to the embodiment;

FIG. 5 is a diagram illustrating a use case 1 in which the embodiment is applied to personal information attribute protection;

FIG. 6 is a diagram illustrating a use case 2 in which the embodiment is applied to anonymous information protection;

FIG. 7 is a diagram illustrating a use case 3 in which the embodiment is applied to cache data protection;

FIG. 8 is a diagram illustrating a use case 4 in which the embodiment is applied to local data protection;

FIG. 9 is a diagram illustrating a use case 5 in which the embodiment is applied to limitation on the number of remote copy;

FIG. 10 is a diagram illustrating a use case 6 in which the embodiment is applied to limitation on the number of local copy; and

FIG. 11 is a diagram illustrating hardware of a computer.

### DESCRIPTION OF THE PREFERRED EMBODIMENTS

Embodiments of the present invention will be described with reference to the drawings.

### Outline of Embodiment

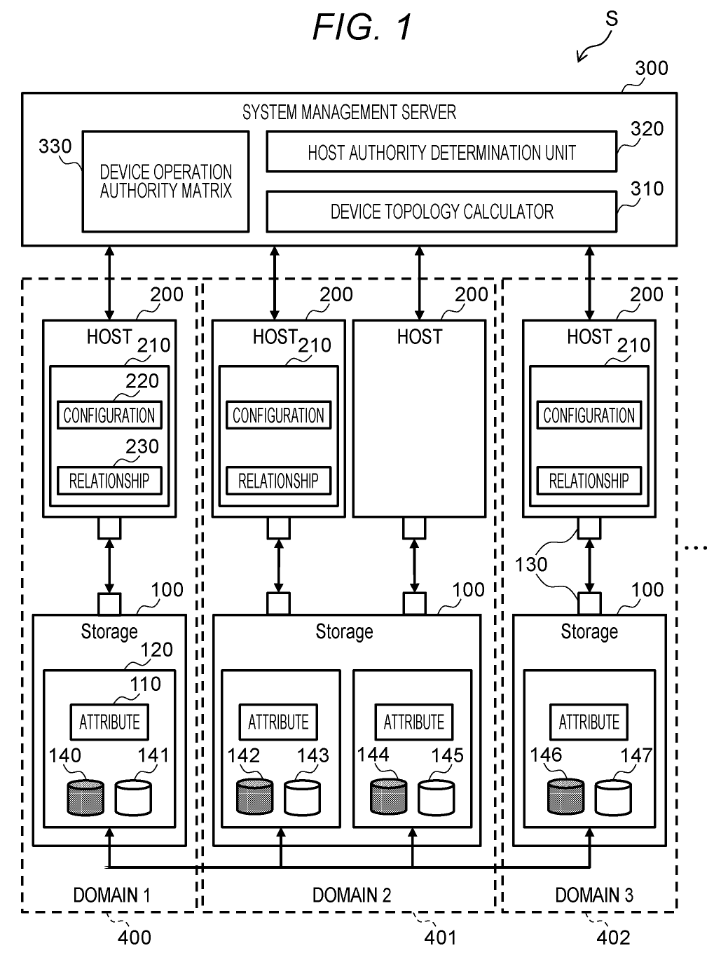

FIG. 1 is a diagram illustrating an example of a configuration of a storage system S according to an embodiment. The storage system S includes a system management server 300 and a plurality of domains 400, 401, and 402. In the present embodiment, the storage system S includes three domains 400, 401, and 402, but the number of domains is not limited to three.

Each domain includes a storage device 100 and a host computer 200. The storage device 100 reads and writes data in response to a request from the host computer 200 via a port 130. The host computer 200 communicates with the system management server 300 via a network and manages and controls the entire system including the storage device 100 and the host computer 200. Although not illustrated in FIG. 1, the system management server 300 may be able to directly communicate with the storage device 100 via a network.

Domains are defined by boundaries of regions, organizations, or the like. The storage device 100 and the host computer 200 belong to any one of the domains. For example, in FIG. 1, three domains 400, 401, and 402 are defined. The domain includes one or more storage devices 100 and one or more host computers 200. A plurality of storage devices 100 and a plurality of host computers 200 may exist in a single domain.

In the storage device 100 of the domain 400, memory devices 140 and 141 for the host computer 200 to read and write data are created, and these devices constitute a device group 120. Device attributes 110 of the memory devices 140 and 141 are defined. The device attribute 110 includes characteristics of data stored in the memory devices 140 and 141, such as a personal information attribute and an anonymous information attribute as described later.

Remote copy of the storage device 100 is performed between the domain 400 and the domain 401 to create memory devices 142 and 143 (duplicate memory devices), which are duplicates of the memory devices 140 and 141 (original memory devices). Local copy of the storage device 100 is performed in the domain 401 to create memory devices 144 and 145 (duplicate memory devices), which are snapshots of the memory devices 142 and 143 (original memory devices). Remote copy of the storage device 100 is performed between the domain 401 and the domain 402 to create memory devices 146 and 147 (duplicate memory devices), which are duplicates of the memory devices 144 and 145 (original memory devices).

The memory devices 140 and 141 are root devices, and the memory devices 142, 143, 144, 145, 146, and 147 are referred to as derivative devices. The memory devices 140 and 141 and the memory devices 142, 143, 144, 145, 146, and 147 are examples of memory devices which the host computer 200 reads data from and writes data to.

Device configuration information 220 indicating the configuration of the device group and the device relationship information 230 indicating the dependency between the device groups are recorded in the host computer 200 by a device management application 210 that is operated by the host computer 200.

Device configuration information 220 and device relationship information 230 according to the embodiment

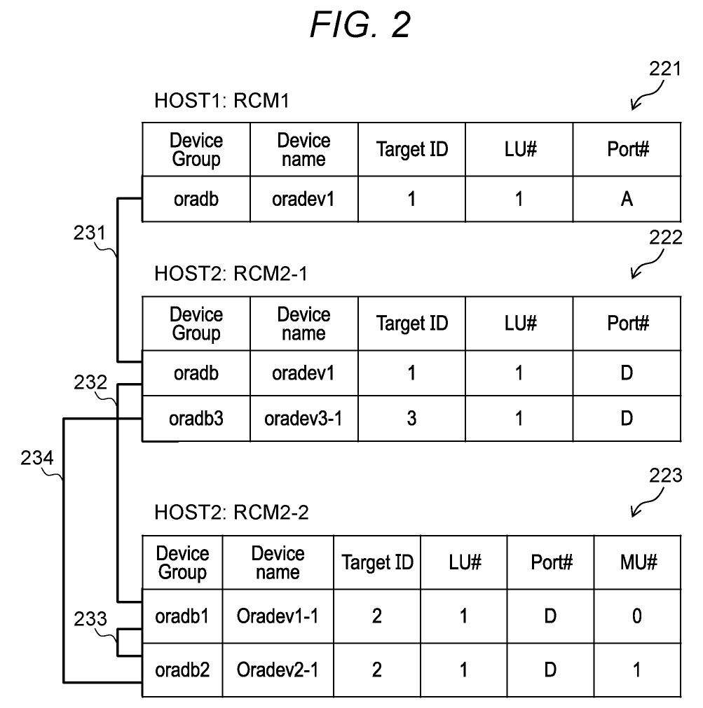

FIG. 2 is a diagram illustrating an example of the device configuration information 220 and the device relationship information 230 (collectively referred to as device information) according to the embodiment. In device configuration information 221 of the host computer 200 (HOST1), a device group oradb and a device oradev1 which is a component of the device group oradb are defined. In device configuration information 222 of the host computer 200 (HOST2), a device group oradb including a device oradev1 and a device group oradb3 including a device oradev3-1 are defined. In device configuration information 223 of the host computer 200 (HOST3), a device group oradb1 including a device oradev1-1 and a device group oradb2 including a device oradev2-1 are defined.

Device relationship information 231 and device relationship information 232 indicate that oradev1 of the host computer 200 (HOST2) and oradev1-1 of the host computer 200 (HOST3) are duplicates of oradev1 of the host computer 200 (HOST1). Device relationship information 233 and device relationship information 234 indicate that oradev2-1 of the host computer 200 (HOST3) and oradev3-1 of the host computer 200 (HOST2) are duplicates of oradev1-1 of the host computer 200 (HOST3).

Accordingly, it can be understood that remote copy of oradev1 has been performed between the storage device 100 connected to the host computer 200 (HOST1) and the storage device 100 connected to the host computer 200 (HOST2). It can also be understood that local copy of oradev1-1 has been performed in the storage device 100 connected to the host computer 200 (HOST3).

All the devices in the storage system S are defined in any one of the pieces of the device configuration information 220. There are one or more pieces of the device configuration information 220 for each domain. There may be a plurality of pieces of the device configuration information 220 for a single domain.

The entire device configuration information 220 and device relationship information 230 are transmitted to the system management server 300 in FIG. 1 and analyzed by a device topology calculator 310. As a result, the topology (dependency graph) of the derivative devices duplicated from the root device is calculated. By propagating the device attributes of the root device to the derivative devices using the calculated topology graph, the device attributes (derivative device attributes) of all the derivative devices in the system can be obtained simply by calculation. The device attribute includes also information on a domain to which the root device belongs (root device domain).

The device configuration information 220 includes host identification information such as information on a connection port between the device and the host computer 200. The domain to which the host computer 200 belongs can be defined using the host identification information. Devices that belong to the same domain and have the same device attribute are given the same operation authority for data governance. The boundary of the domain may be a physical boundary or a virtual boundary.

### Device Operation Authority Determination Matrix 330 According to the Embodiment

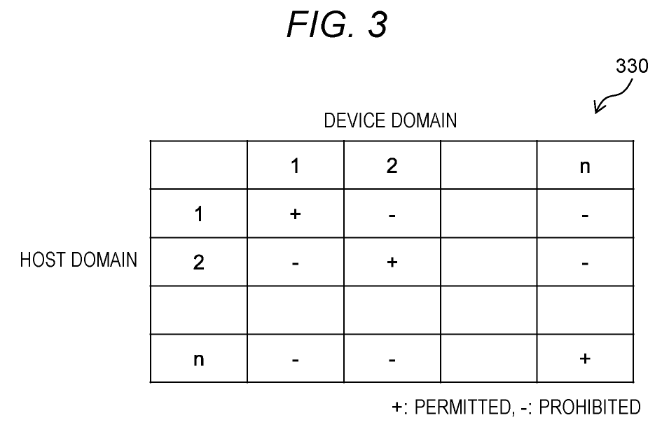

FIG. 3 is a diagram illustrating an example of a device operation authority determination matrix 330 according to the embodiment. The device operation authority determination matrix 330 is provided in advance for each device attribute. When the domain of the host computer 200 as an operation source and the domain of the operation target among the memory devices are identified, the host authority determination unit 320 can determine, using the device operation authority determination matrix 330, the authority of the host computer 200 as an operation source to operate the operation target among the memory devices. In the device operation authority determination matrix 330, the domain number of the host computer 200 as an operation source is listed along the vertical direction, the domain number of the operation target among the memory devices is listed along the horizontal direction, and the authority to operate the operation target among the memory devices is shown at a place corresponding to the domain number of the operation source and the domain number of the operation target.

The device operation authority determination matrix 330 illustrated in FIG. 3 shows that authority is granted without limitation when the host computer 200 as an operation source and the operation target among the memory devices belong to the same domain, but that no authority is granted when the host computer 200 as an operation source and the operation target among the memory devices belong to different domains. By writing the device operation authority determination matrix 330 so as to match various kinds of compliance, authorities are determined properly and the storage devices operate properly according to determination results.

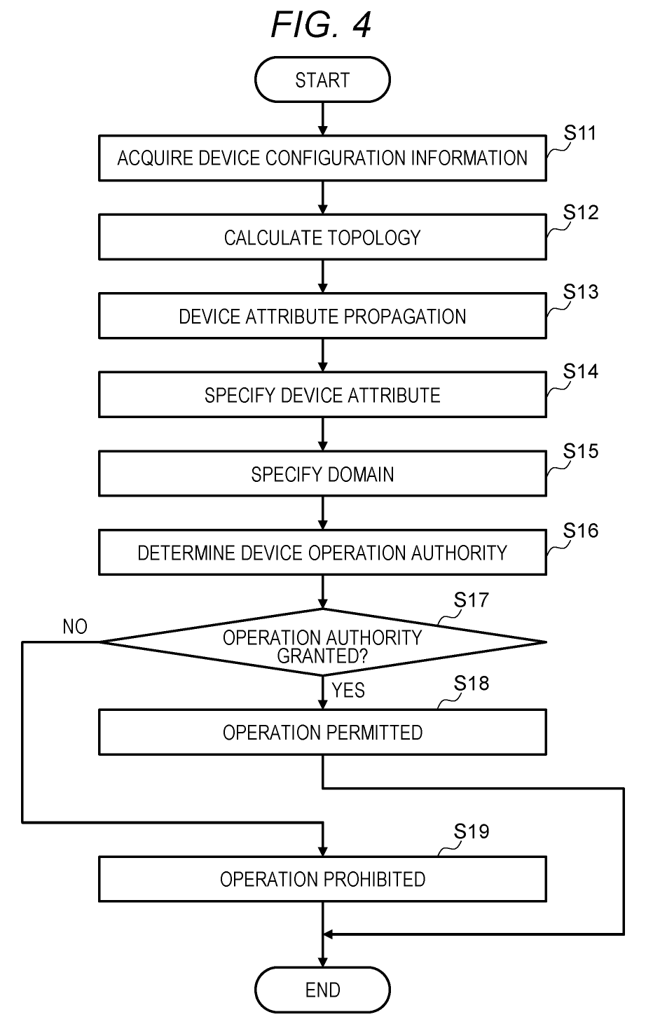

The device operation authority determination matrix 330 may be incorporated as a determination logic into a program of device operation authority determination processing (FIG. 4).

### Device Operation Authority Determination Processing According to the Embodiment

FIG. 4 is a flowchart illustrating the device operation authority determination processing according to the embodiment. The device operation authority determination processing is executed for the system management server 300 every time a user inputs an operation instruction from the host computer 200 as an operation source to a logical drive as an operation target. The “operation” broadly includes various accesses such as access for creating a volume. The logical drive includes one or a plurality of physical drives such as a hard disk drive (HDD) and a solid state drive (SSD).

First, in step S11, the device topology calculator 310 acquires the device configuration information 220 from each of the host computers 200 to be managed by the system management server 300. In step S12, the device topology calculator 310 analyzes the device configuration information 220 acquired in step S11 and calculates the topology of the devices, and then generates the device relationship information 230 as illustrated in FIG. 2.

In step S13, the host authority determination unit 320 causes, using the device relationship information 230 generated in step S12, the device attribute of the root device to propagate to all the derivative devices of the root device, and determines the device attribute of each derivative device. In step S14, the host authority determination unit 320 specifies the device attribute of the operation target among the memory devices from the derivative device attribute derived in step S13. In step S15, the host authority determination unit 320 refers to the device configuration information 220 and specifies the domain of the host computer 200 as an operation source and the domain of the operation target among the memory devices.

In step S16, the host authority determination unit 320 refers to the device operation authority determination matrix 330 corresponding to the device attribute specified in step S14. The host authority determination unit 320 determines the operation authority corresponding to the domain of the host computer 200 as an operation source and the domain of the operation target among the memory devices specified in step S15.

In step S17, the host authority determination unit 320 determines whether the determination result of step S17 indicates grant of operation authority. When operation authority is granted (YES in step S17), the host authority determination unit 320 proceeds to step S18. When operation authority is not granted (NO in step S17), the host authority determination unit 320 proceeds to step S19.

In step S18, the host authority determination unit 320 permits the host computer 200 as an operation source to perform an operation. In step S19, the host authority determination unit 320 prohibits the host computer 200 as an operation source from performing an operation.

### Effects of Embodiment

As described above, in the present embodiment, the device topology is calculated from the device configuration information 220 and the device relationship information 230, and the device attributes of all the derivative devices included in the topology are calculated from the device topology and the device attribute of the root device. The domain of the device and the domain of the host computer 200 are specified from the identification information of the host computer 200 connected to the device. The device operation authority is determined using the device operation authority determination matrix 330. Since the process of determining the device operation authority is executed based on only static information, there is no management overhead during a normal operation of the system management server 300.

Note that the method of deriving the device attribute of the root device based on the device topology calculated based on the device configuration information 220 and the device relationship information 230 and determining the device operation authority using the device operation authority determination matrix 330 is merely an example. That is, there are various methods that are for determining the operation authority to operate the operation target among the memory devices from the host computer as an operation source based on the device attribute of the operation target among the memory devices and the domains of the host computer as an operation source and the operation target among the memory devices, and by which the same result is obtained.

### Exemplary Modifications of Embodiment

In the above-described embodiment, the system management server 300 includes the device topology calculator 310 and the host authority determination unit 320 and performs calculation of the device topology and determination of the operation authority of the host computer 200. The present invention is not limited thereto, and a part or the entire processing of the system management server 300 may be offloaded to the host computer 200. That is, a part or the entire processing of the device topology calculator 310 and the host authority determination unit 320 may be offloaded to the host computer 200 and executed by one or more host computers 200.

### Use case 1 of Embodiment

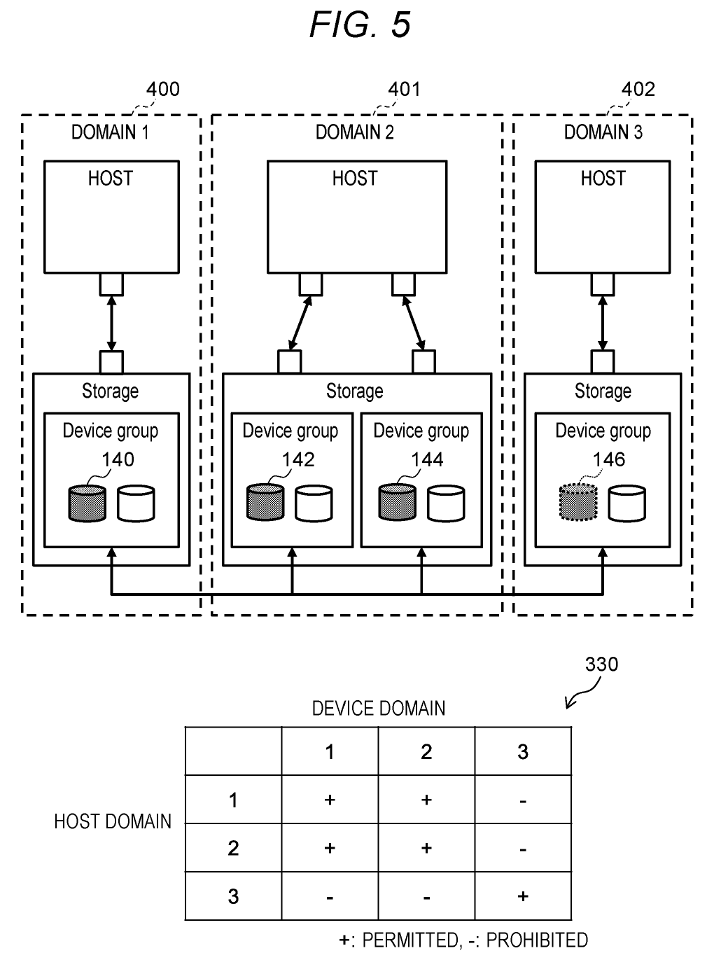

FIG. 5 is a diagram illustrating a use case 1 in which the embodiment is applied to personal information attribute protection. In the use case 1, the device attribute is “personal information attribute” indicating that the data stored in a memory device includes personal information. In FIG. 5, domains 400 and 401 are domestic domains, and a domain 402 is an international (regulated country) domain. FIG. 5 illustrates how a memory device 140 storing information having the personal information attribute is duplicated from the domain 400, which is a root domain, as memory devices 142 and 144 in the domain 401 and as a memory device 146 in the domain 402. In device operation authority determination matrix 330 illustrated in FIG. 5, there is no restriction on the operation authority between domestic domains (in the same domain and between a domain 1 and a domain 2) where there is no restriction on duplicating a device that stores information having an attribute corresponding to personal information. In the device operation authority determination matrix 330 illustrated in FIG. 5, the operation authority is restricted between regulated countries (between the domain 1 and a domain 3 and between the domain 2 and the domain 3).

### Use case 2 of Embodiment

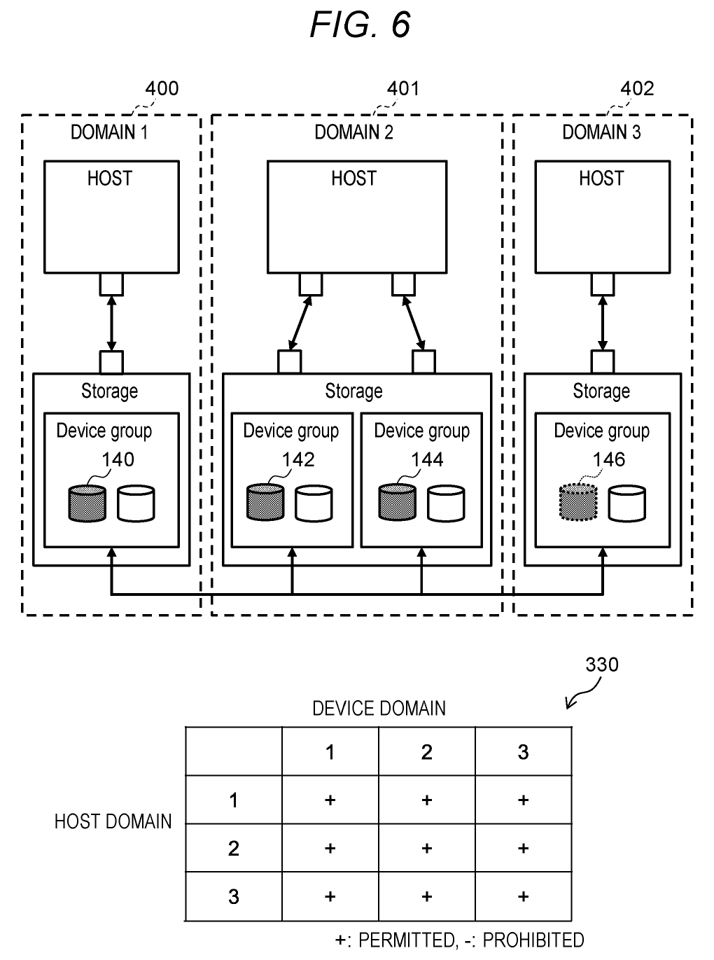

FIG. 6 is a diagram illustrating a use case 2 in which the embodiment is applied to anonymous information protection. In the use case 2, the device attribute is “anonymous information attribute” indicating that the data stored in a memory device includes anonymous information in which personal information is anonymized. In FIG. 6, domains 400 and 401 are domestic domains, and domain 402 is an international (regulated country) domain. FIG. 6 illustrates how a memory device 140 storing information having the anonymous information attribute is duplicated from the domain 400, which is a root domain, as memory devices 142 and 144 in the domain 401 and as a memory device 146 in the domain 402. In device operation authority determination matrix 330 illustrated in FIG. 6, there is no restriction on operation authority for all the combinations of domains for duplicating a device that stores information having an attribute corresponding to anonymous information that needs to keep anonymity.

As described above, properly setting the operation authority in the device operation authority determination matrix 330 according to the use cases 1 and 2 enables complying with the Act on the Protection of Personal Information and the like at low cost.

### Use case 3 of Embodiment

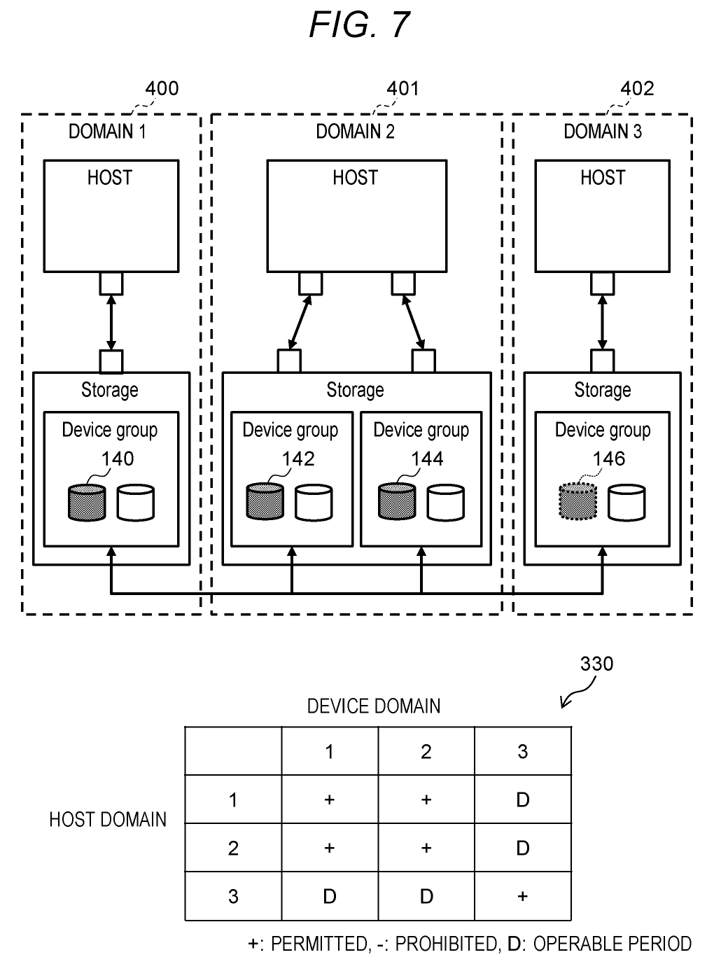

FIG. 7 is a diagram illustrating a use case 3 in which the embodiment is applied to cache data protection. In the use case 3, the device attribute is “cache attribute” indicating that a time period in which an operation of a memory device is allowed is limited. In FIG. 7, a domain 400 is an on-premises domain, a domain 401 is a near cloud domain, and a domain 402 is a public cloud domain. The configuration illustrated in FIG. 7 is typical in a use case in which on-premises data is used in a near cloud or a public cloud. The public cloud is used on demand for a certain period of time, and is terminated or deleted when its use ends.

FIG. 7 illustrates how a memory device 140 having the cache attribute indicating that data is temporarily stored is duplicated from the domain 400, which is a root domain, as memory devices 142 and 144 in the domain 401 and as a memory device 146 in the domain 402. In device operation authority determination matrix 330 illustrated in FIG. 7, there is no restriction on operation authority between the on-premises domain and the near cloud domain, and operation authority is granted for a limited time period between the on-premises domain and the public cloud and between the near cloud domain and the public cloud. “D” in the device operation authority determination matrix 330 indicates an operable time period. The corresponding operation is allowed within the time period but is not allowed outside the time period. Accordingly, data access to the public cloud cannot be made outside the valid period, thus the risk of information leakage caused by attack to a server or the like can be reduced.

### Use case 4 of Embodiment

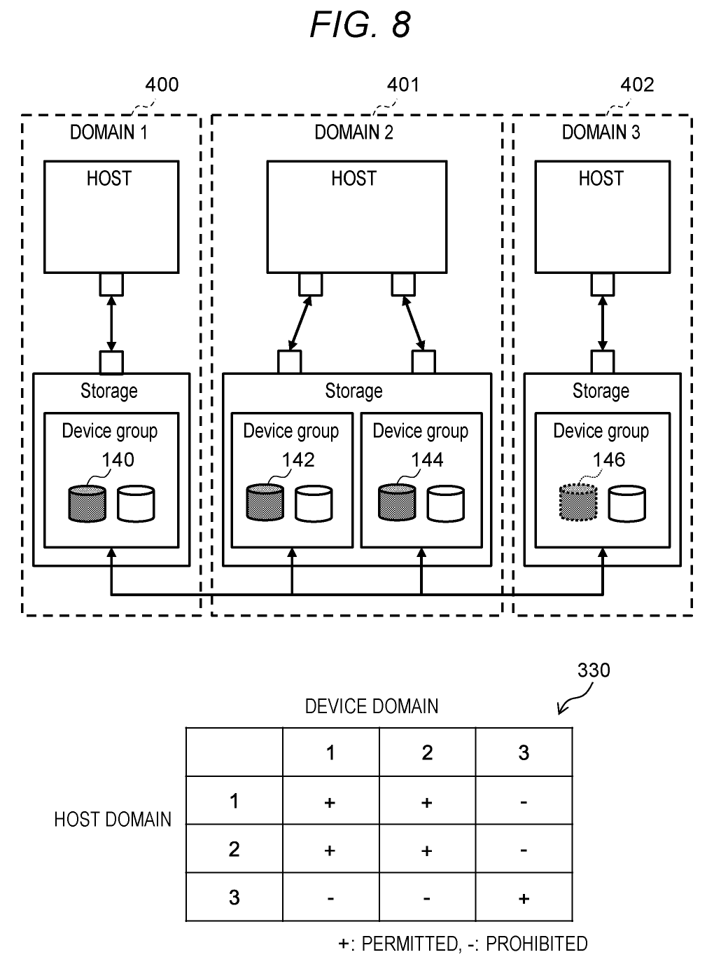

FIG. 8 is a diagram illustrating a use case 4 in which the embodiment is applied to local data protection. In the use case 4, the device attribute is “local attribute” indicating that a domain of a memory device that can be operated by a host computer 200 is limited. In FIG. 8, a domain 400 is an own company domain, a domain 401 is an own company group domain, and a domain 402 is a third-party company domain. In FIG. 8, data is freely distributed within the own company group, and distribution to and from a third-party company is prohibited as a rule. FIG. 8 illustrates how a memory device 140 that stores information having the local attribute is duplicated from the domain 400, which is a root domain, as memory devices 142 and 144 in the domain 401 and as a memory device 146 in the domain 402. Device operation authority determination matrix 330 illustrated in FIG. 8 restricts the operation authority between the own company or the own company group and a third-party company. The device operation authority determination matrix 330 can be temporarily changed to grant authority between the own company or the own company group and a third-party company for a limited time period. Accordingly, by only setting the device operation authority determination matrix 330, data distribution to and from a third-party company can be properly controlled.

### Use case 5 of Embodiment

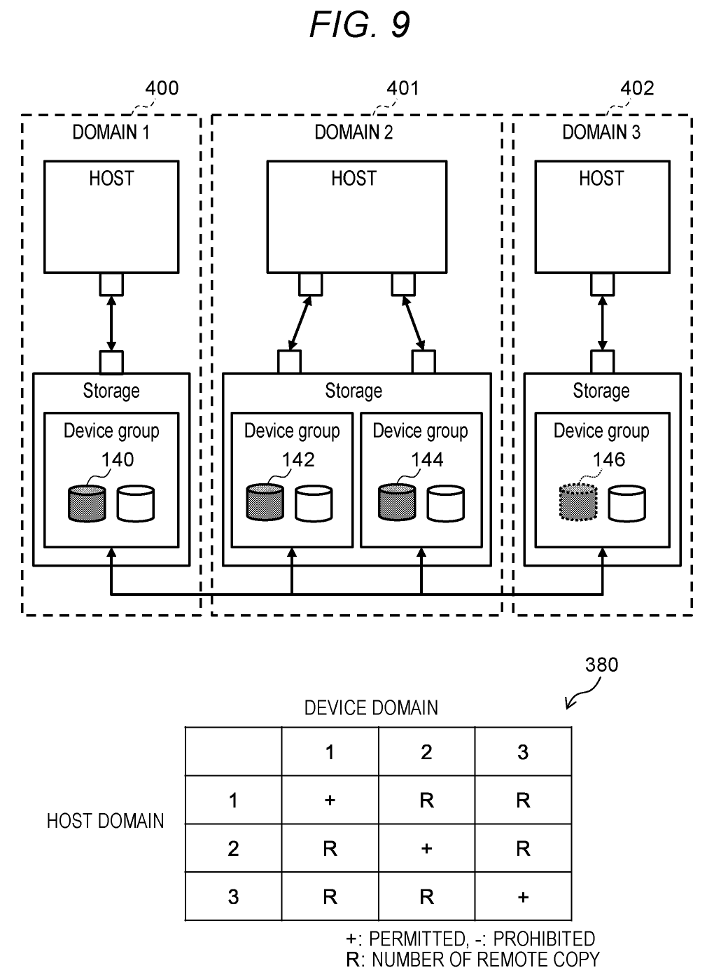

FIG. 9 is a diagram illustrating a use case 5 in which the embodiment is applied to limitation on the number of remote copy. In the use case 5, the device attribute is “remote copy limiting attribute” indicating that the number of creating remote copies in a memory device is limited. FIG. 9 illustrates how a memory device 140 having the remote copy limiting attribute is duplicated from a domain 400, which is a root domain, as memory devices 142 and 144 in a domain 401 and as a memory device 146 in a domain 402. Remote copy is performed to synchronize data between independent domains (sites). Device operation authority determination matrix 330 illustrated in FIG. 9 limits the number of performing remote copy between domains.

In the device operation authority determination matrix 330 illustrated in FIG. 9, there is no restriction on operation authority within the same domain, but the operation authority is restricted between different domains. “R” in the device operation authority determination matrix 330 indicates a limit number of performing remote copy. Remote copy can be performed while the counted-up number of remote copy performed is equal to or less than the limit number, but is prohibited when the counted-up number exceeds the limit. Accordingly, the number of duplications made across domains can be limited to a certain number or less, which reduces the risk of information leakage due to data diffusion.

Note that the remote copy limiting attribute is not limited to limitation on the number of remote copies that can be created in a memory device. Limitation may be set on a time period in which remote copy is allowed. Further, the remote copy limiting attribute may have different limits on the number of remote copy or on the time period in which remote copy is allowed for different types of remote copy. Setting different limits for different types of remote copy enables precisely controlling prevention of information leakage according to the type of remote copy.

### Use case 6 of Embodiment

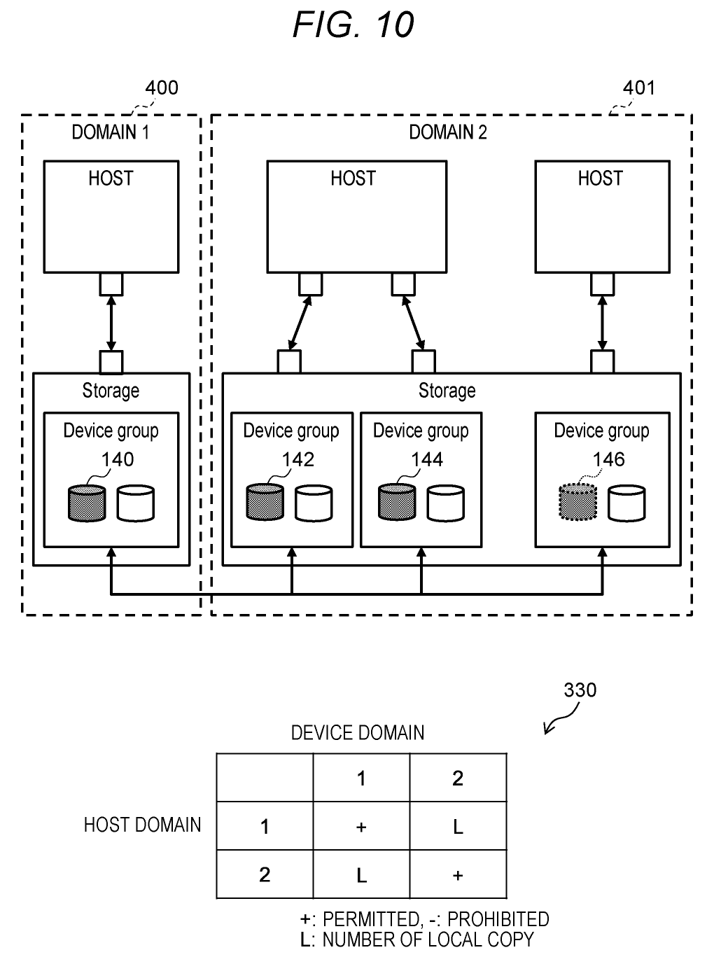

FIG. 10 is a diagram illustrating a use case 6 in which the embodiment is applied to limitation on the number of local copy. In the use case 6, the device attribute is “local copy limiting attribute” indicating that the number of creating local copies in a memory device is limited. FIG. 10 illustrates how duplication of a memory device 140 having the local copy limiting attribute is performed from a domain 400, which is a root domain, to a domain 401 and then within the domain 401. Local copy is performed to duplicate data within a domain (site), and is usually performed to save a data image as a snapshot at a specific timing. Device operation authority determination matrix 330 illustrated in FIG. 10 limits the number of local copy performed within the same domain.

In the device operation authority determination matrix 330 illustrated in FIG. 10, there is no restriction on operation authority within the same domain, but operation authority is restricted between different domains. “L” in the device operation authority determination matrix 330 indicates a limit number of performing local copy. Local copy can be performed while the counted-up number of local copy performed is equal to or less than the limit number, but is prohibited when the counted-up number exceeds the limit. Accordingly, the number of local copies made can be limited to a certain number or less, which reduces the risk of information leakage due to data diffusion.

Note that the local copy limiting attribute is not limited to a limitation on the number of local copies that can be created in a memory device. Limitation may be set on a time period in which local copy is allowed. Further, the local copy limiting attribute may have different limits on the number of local copy or on the time period in which local copy is allowed for different types of local copy. Setting different limits for different types of local copy enables precisely controlling prevention of information leakage according to the type of local copy.

### Hardware of Computer 1000

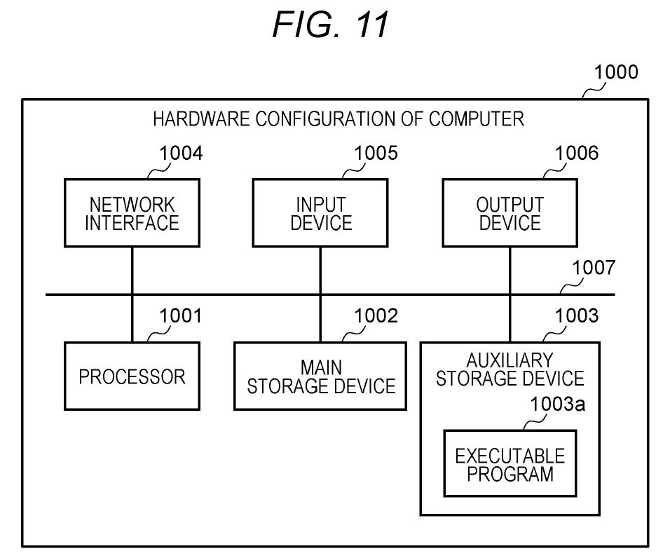

FIG. 11 is a diagram illustrating hardware of a computer 1000. The computer 1000 executes a predetermined program to perform functions of a storage device 100, a host computer 200, and a system management server 300.

The computer 1000 includes a processor 1001 such as a CPU, a main storage device 1002, an auxiliary storage device 1003, a network interface 1004, an input device 1005, and an output device 1006 connected to one another via an internal communication line 1007 such as a bus.

The processor 1001 controls operations of the entire computer 1000. The main storage device 1002 includes, for example, a volatile semiconductor memory, and is used as a work memory for the processor 1001. The auxiliary storage device 1003 includes one or more hard disk devices, solid state drives (SSDs), or large-capacity nonvolatile storage devices such as flash memories and is used to store various programs and data for a long period of time. An executable program 1003a stored in the auxiliary storage device 1003 is loaded into the main storage device 1002 when the computer 1000 is started or when necessary and is executed by the processor 1001.

The executable program 1003a may be recorded in a non-transitory recording medium, read from the non-transitory recording medium by a medium reading device, and loaded into the main storage device 1002. Alternatively, the executable program 1003a may be acquired from an external computer via a network and loaded into the main storage device 1002.

The network interface 1004 is an interface device for connecting the computer 1000 to the networks in the system or for communicating with other computers. The network interface 1004 includes, for example, a network interface card (NIC) for a wired local area network (LAN) or a wireless LAN.

The input device 1005 includes a keyboard, a pointing device such as a mouse, and the like, and is used by a user to input various instructions and information to the computer 1000. The output device 1006 includes, for example, a display device such as a liquid crystal display and an organic electro luminescence (EL) display, and an audio output device such as a speaker, and is used to present necessary information to the user when necessary.

The present invention is not limited to the above-described embodiments (and the use cases), and includes various exemplary modifications. For example, the embodiments have been described in detail for easy understanding of the present invention. The present invention is not necessarily limited to embodiments including all the described configurations. In addition, a part of the configuration of the embodiment can be replaced with a configuration of another embodiment, and a configuration of an embodiment can be added to a configuration of another embodiment. A part of a configuration of an embodiment may be eliminated or replaced, or a different configuration may be added to the part. Some or all of the above-described configurations, functions, processing units, processing means, and the like may be realized by hardware, for example, by designing involving an integrated circuit. Each of the above-described configurations, functions, and the like may be realized by software by a processor interpreting and executing programs for realizing functions.

What is claimed is:

1. A storage system comprising:
a host computer; and
a storage device including a memory device from which the host computer reads data and to which the host computer writes data, wherein
the host computer and the storage device are provided for each domain,
the storage system manages
device information including information indicating a correspondence between the host computer and the memory device from which the host computer reads data and to which the host computer writes data, information from which the domain to which the host computer belongs and the domain to which the memory device belongs are specified, and information indicating a duplication relationship between the memory devices, and
a processor of the storage system
specifies based on the device information, when an instruction to operate the memory device is received from the host computer, one among the memory devices and having the duplication relationship with an operation target among the memory devices,
determines, according to an attribute of the one among the memory devices that has been specified, an attribute of the operation target among the memory devices,
specifies, based on the device information, the domain to which the host computer as an operation source belongs and the domain to which the operation target among the memory devices belongs,
determines, based on the attribute of the operation target among the memory devices and the domain to which the host computer as an operation source belongs and the domain to which the operation target among the memory devices belongs, authority to operate the operation target among the memory devices from the host computer as an operation source, and
operates the operation target among the memory devices when determination is made that the authority is granted.

2. The storage system according to claim 1, wherein
the memory device is a logical drive having a port.

3. The storage system according to claim 1, wherein
the attribute includes a personal information attribute indicating that data stored in the memory device includes personal information, or an anonymous information attribute indicating that the data includes anonymous information obtained by anonymizing personal information.

4. The storage system according to claim 1, wherein
the attribute includes a cache attribute indicating a time period in which an operation of the memory device is allowed is limited.

5. The storage system according to claim 1, wherein
the attribute includes a local attribute indicating that the memory device operable by the host computer belongs to the domain that is specified.

6. The storage system according to claim 1, wherein
the attribute includes a remote copy limiting attribute indicating that a number of remote copies created in the memory device or a time period during which remote copy is allowed is limited, or a local copy limiting attribute indicating that a number of local copies created in the memory device or a time period during which local copy is allowed is limited.

7. The storage system according to claim 6, wherein
the number of remote copies and the time period during which the remote copy is allowed in the remote copy limiting attribute are different for different types of the remote copy, and
the number of local copies and the time period in which the local copy is allowed in the local copy limiting attribute are different for different types of the local copy.

8. A management server for managing a storage device including a host computer and a storage device that includes a memory device from which the host computer reads data and to which the host computer writes data, wherein
the host computer and the storage device are provided for each domain,
device information including information indicating a correspondence between the host computer and the memory device from which the host computer reads data and to which the host computer writes data, information from which the domain to which the host computer belongs and the domain to which the memory device belongs are specified, and information indicating a duplication relationship between the memory devices is managed, and
a processor of the management server
specifies based on the device information, when an instruction to operate the memory device is received from the host computer, one among the memory devices and having the duplication relationship with an operation target among the memory devices,
determines, according to an attribute of the one among the memory devices that has been specified, an attribute of the operation target among the memory devices,
specifies, based on the device information, the domain to which the host computer as an operation source belongs and the domain to which the operation target among the memory devices belongs,
determines, based on the attribute of the operation target among the memory devices and the domain to which the host computer as an operation source belongs and the domain to which the operation target among the memory devices belongs, authority to operate the operation target among the memory devices from the host computer as an operation source, and
permits, when determination is made that the authority is granted, the host computer as an operation source to operate the operation target among the memory devices.

9. An access control method for a storage system including a host computer and a storage device that includes a memory device from which the host computer reads data and to which the host computer writes data, the access control method being executed by the storage system, wherein
the host computer and the storage device are provided for each domain,
the storage system manages
device information including information indicating a correspondence between the host computer and the memory device from which the host computer reads data and to which the host computer writes data, information from which the domain to which the host computer belongs and the domain to which the memory device belongs are specified, and information indicating a duplication relationship between the memory devices, and
a processor of the storage system performs
specifying based on the device information, when an instruction to operate the memory device is received from the host computer, one among the memory devices and having the duplication relationship with an operation target among the memory devices,
determining, according to an attribute of the one among the memory devices that has been specified, an attribute of the operation target among the memory devices,
specifying, based on the device information, the domain to which the host computer as an operation source belongs and the domain to which the operation target among the memory devices belongs,
determining, based on the attribute of the operation target among the memory devices and the domain to which the host computer as an operation source belongs and the domain to which the operation target among the memory devices belongs, authority to operate the operation target among the memory devices from the host computer as an operation source, and
operating the operation target among the memory devices when determination is made that the authority is granted.
